(19) United States
(12) Patent Application Publication
(10) Pub. No.: US 2005/0231771 A1
(43) Pub. Date: Oct. 20, 2005

(54) Scanner and method thereof

(76) Inventors: Ming-Fu Hsu, Hsinchu City (TW); Sei-For Hsu, Jhubei City (TW); Hung-Yi Hsu, Taoyuan City (TW); Shing-Chia Chen, Ciaotou Township (TW)

Correspondence Address: RABIN & Berdo, PC, 1101 14TH STREET, NW, SUITE 500, WASHINGTON, DC, 20005, US

(21) Appl. No.: 11/104,481

(22) Filed: Apr. 13, 2005

(30) Foreign Application Priority Data
Apr. 14, 2004 (TW) 93110383

(51) Int. Cl. H04N 1/04

(52) U.S. Cl. 358/497

(57) ABSTRACT

A scanner includes an optical module, a driving device, a digital gain unit and a timer. The optical module includes a photo sensing device for reading N scan lines and outputs digital image data. The driving device drives the optical module and has a position detecting device for outputting a position feedback signal corresponding to a position of the optical module. The digital gain unit performs a digital gain process on the digital image data. The timer controls the digital gain process according to the position feedback signal. The method includes setting K to 1; driving the optical module to read a Kth scan line of the to-be-scanned document and outputting Kth image data; calculating Kth exposure time for the Kth scan line and performing a digital gain process on the Kth image data; and determining if K is smaller than N.

This application claims the benefit of Taiwan application Serial No. 93110383 filed Apr. 14, 2004, the subject matter of which is incorporated herein by reference.

### BACKGROUND OF THE INVENTION

1. Field of the Invention

The invention relates in general to a scanner and method thereof, and more particularly to a scanner with a driving device for feedback control and method thereof.

2. Description of the Related Art

With the advancing of the image processing technology, the scanner has become an indispensable image capturing device, while the motor is an essential element for driving a photo sensing device to capture images. A direct current (DC) motor with the advantages of small size, low noise, low power consumption and low cost has now been widely adopted in a scanner.

Referring to FIG. 1A, a structural diagram of a DC motor-based scanner according to prior arts is shown. The scanner 100 includes a scan flatbed 110, an optical module 120, a DC motor 130 and an application specific integrated circuit (ASIC) 140. The DC motor 130 drives the optical module 120 to move at a constant speed, meanwhile, the photo sensing device (not shown in the diagram) of the optical module 120, a charge coupled device (CCD) for example, is for capturing images of several scan lines of the to-be-scanned document 111 on the scan flatbed 110. The DC motor 130 has an encoder 132 for outputting a position feedback signal TG. The ASIC 140 controls the DC motor 130 according to a position feedback signal PF to precisely position the optical module 120 to assure a uniform image captured from each scan line.

However, due to slight variation of the speed of the driving device, the exposure time for each scan line varies. As shown in FIG. 1B, the scanner 100 determines the exposure time T1, T2, and T3 of the to-be-scanned document 111 according to the triggering of the position related signal PF. If the DC motor 130 drives the optical module 120 to move at a predetermined constant speed, the exposure time of a scan line is set to be T1=t2−t0. If the DC motor 130 drives the optical module 120 to read a certain scan line at a speed larger than the predetermined constant speed, the exposure time of this scan line is set to be T2=t1−t0. If the DC motor 130 drives the optical module 120 to read a certain scan line at a speed smaller than the predetermined constant speed, the exposure time of this scan line is set to be T3=t3−t0. Since the exposure starting point and ending point of each scan line is both controlled by the feedback position related signals, the exposure time T1, T2, and T3 for reading different scan lines will be unequal. According to the formula: the exposure level=light density of the to-be-scanned document 111×responsivity of the photo sensing device 122×exposure time×analog front end (AFE) gain, the exposure level of each scan line is not constant, thereby reducing scan image quality.

Referring to FIG. 1C, a circuit block diagram of the scanner using a DC motor for the position feedback control disclosed by U.S. Pat. No. 6,037,584 is shown. For the light density of the to-be-scanned document 111 and the responsivity of the photo sensing device is usually constant throughout the whole scan process, in order to solve the above-mentioned issue of unequal exposure level for each scan line, the patent dynamically adjusts the AFE gain to compensate the different exposure time such that the exposure time of each scan line is equal.

The scanner 150 drives the optical module 170 to scan the to-be-scanned document (not shown in the diagram) by the DC motor 160. The DC motor 160 has an encoder 162 for outputting a position related signal PF to the timer 182 of the ASIC 180. The exposure control unit 184 controls the exposure time of the CCD 172 of each scan line of the to-be-scanned document according to the position related signal PF. The data read by the CCD 172 are output to the analog amplifying unit for further amplification. The ASIC 180 of the patent further includes a gain control unit 186. The gain control unit 186 dynamically adjusts the AFE gain of the analog amplification unit 174 to compensate the varied exposure level due to the unequal exposure time of each scan line according to the control of the exposure control unit 184 and the timer 182.

However, the scanner disclosed by the above-mentioned patent requires extra complicated circuits, such as the gain control unit 186, thereby increasing the manufacturing cost, in order to dynamically adjust the AFE gain. Moreover, the AFE gain compensation is to compensate exposure level of the present scan line according to exposure level deviation of the previous scan line. The gain process is easily interfered by the exterior and thus not able to provide a precise compensation, and the linearity of the analog signal compensation is poor.

### SUMMARY OF THE INVENTION

It is therefore an object of the invention to provide a scanner, using a post-processing method to perform digital gain compensation on the captured CCD data, so that exposure level is the same for each scan line and that the quality of image scanning is improved.

The invention achieves the above identified object by providing a scanner including an optical module, a driving device, a digital gain unit and a timer. The light source is for emitting a light beam to illuminate a to-be-scanned document. The optical module, including a photo sensing device for receiving the light beam reflected by the to-be-scanned document to read a number of scan lines of the to-be-scanned document and outputting corresponding digital image data. The driving device is for generating a relative movement between the optical module and the to-be-scanned document. The driving device includes a position detecting device for detecting a relative position of the optical module to the to-be-scanned document and accordingly outputting a position feedback signal. The digital gain unit is for performing a digital gain process on the digital image data. The timer is for controlling the digital gain process according to the position feedback signal to dynamically compensate the exposure level of each scan line.

The invention achieves another object of the invention by providing a scanning method applied in a scanner for scanning N scan lines of the to-be-scanned document, wherein N is a natural number. The steps of the method includes setting a K value to 1; reading a Kth scan line of the to-be-scanned document and accordingly outputting Kth image data; calculating Kth exposure time for the Kth scan line; and performing a digital gain process on the Kth image data according to the Kth exposure time to compensate exposure level of the Kth scan line. By adopting the digital gain post-processing, the exposure level of each scan line can be compensated and the quality of image scanning can be improved.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a structural diagram of a DC motor based scanner according to prior arts;

FIG. 1B is an exposure timing control diagram of the CCD in FIG. 1A;

FIG. 1C is a circuit diagram of a DC motor based scanner disclosed in US Patent Application 6037584;

FIG. 2A is a structural diagram of the scanner according to a preferred embodiment of the invention;

FIG. 2B is a vertical view of the scanner in FIG. 2A;

FIG. 2C is a structure diagram of the scanner 200 in FIG. 2A using an automatic document feeder (ADF).

FIG. 2D is a diagram of ADF buffer-full avoiding control in the scanner of FIG. 2C.

FIG. 3 is a flowchart of a scanning method according to a preferred embodiment of the invention.

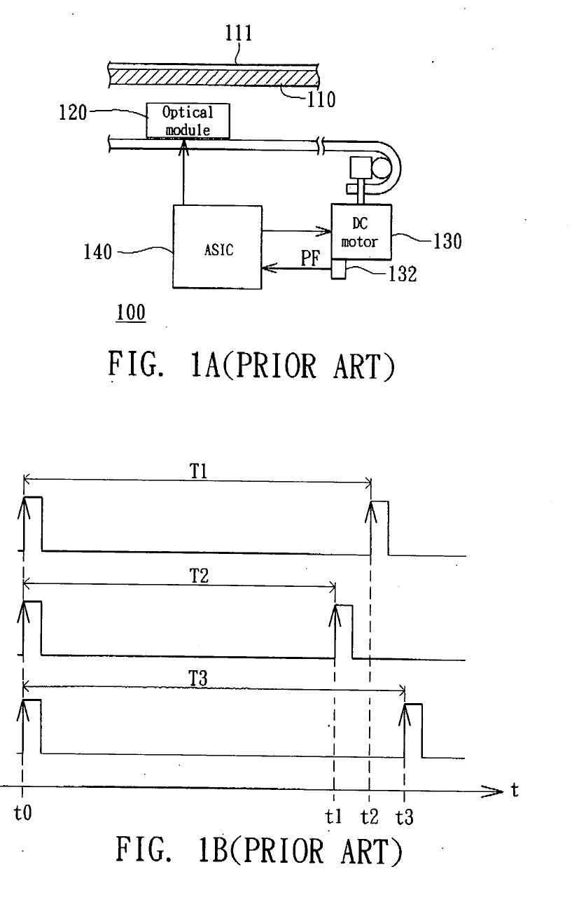

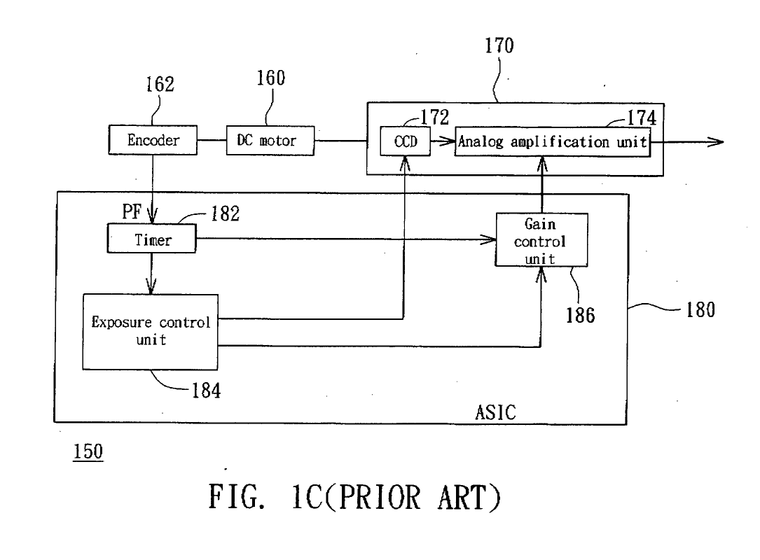

### DETAILED DESCRIPTION OF THE INVENTION

The main feature of the invention lies in adopting a post-processing method to perform a digital gain process on the image data captured by the photo sensing device to compensate variation in exposure time of the photo sensing device for reading each scan line to achieve a consistent image quality in a DC motor based scanner.

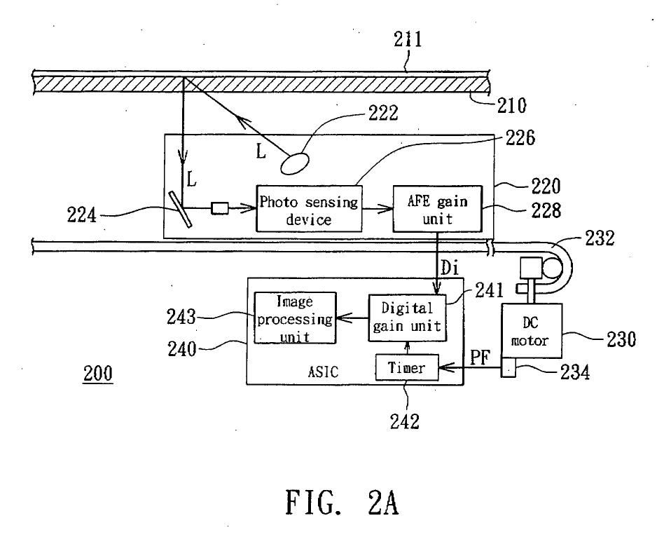

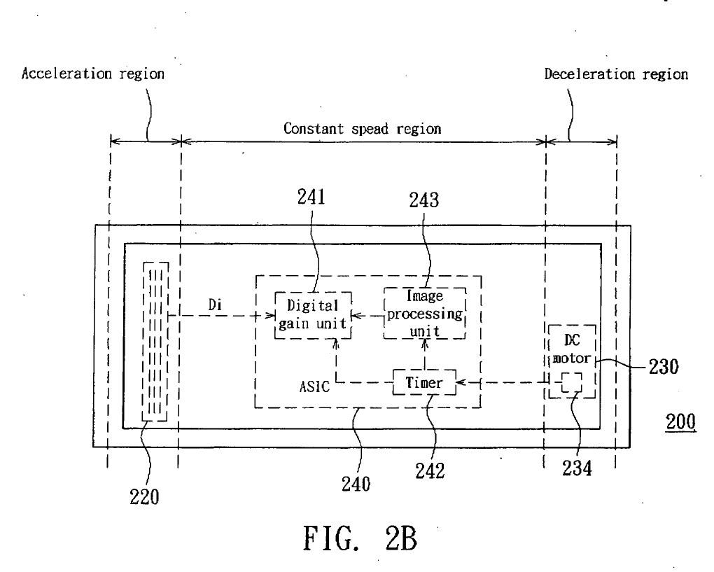

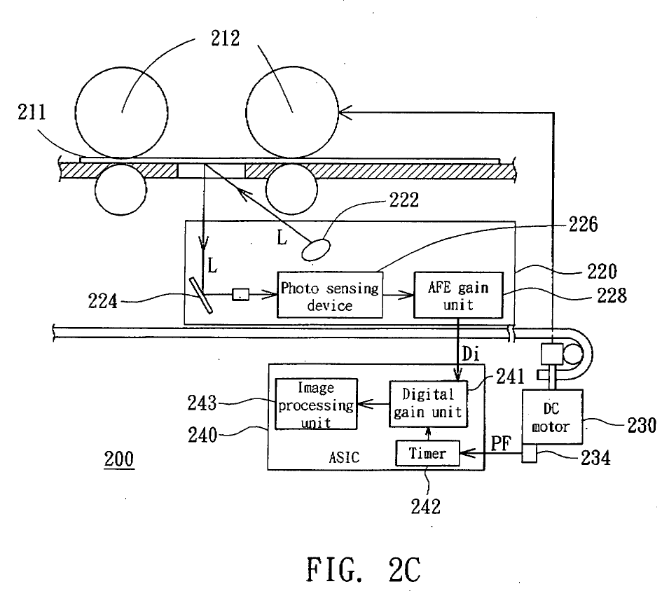

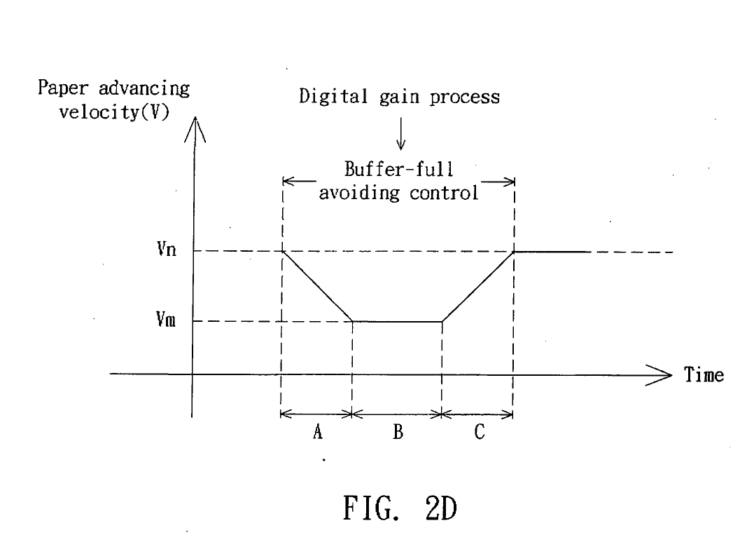

Referring to FIG. 2A, a structural diagram of the scanner according to a preferred embodiment of the invention is shown. Scanner 200 includes a scan flatbed 210, an optical module 220, a DC motor 230 and an application specific integrated circuit (ASIC) 240. The scan flatbed 210 is for carrying the to-be-scanned document 211 (a reflective document for example). The optical module 220 includes a light source 222, a mirror 224, a photo sensing device 226 and an analog front end (AFE) gain unit 228, wherein the photo sensing device 226 can be a CCD (charge coupled device) or a contact image sensor (CIS) for example.

The light source 222 is for emitting a light beam L to the to-be-scanned document 211. The light beam L, after being reflected by the to-be-scanned document 211 and the mirror 224, is received by the photo sensing device 226. The photo sensing device 226 is for reading N scan lines of the to-be-scanned document 211 (not shown in the diagram) then outputting the image data corresponding to each scan line, where N is a natural number. For example, for a scanner with a resolution of 600 dpi, the photo sensing device 226 reads 600 scan lines of the to-be-scanned document 211 per inch. The AFE gain unit 228 performs an AFE gain process on the image data read by the photo sensing device 226 then outputs digital image data Di corresponding to each scan line.

The DC motor 230 uses the timing belt 232 to drive the optical module 220. The DC motor 230 has an encoder 234, which outputs a position feedback signal PF corresponding to a position of the optical module 220 relative to the to-be-scanned document 211. Besides, the ASIC 240 includes a digital gain unit 241, a timer 242 and an image processing unit 243. The digital gain unit 241 is for performing a digital gain process on the digital image data Di outputted by the AFE gain unit 228. The digital gain operation of the invention performs digital compensation on exposure level variation of a scan line before performing pixel response non-uniformity (PRNU) operation as in the prior art.

The timer 242 calculates exposure time of each scan line read by the photo sensing device 226 according to the position feedback signal PF and controls digital gain operation to dynamically compensate exposure level variation between different scan lines. Unlike the method according to prior arts which uses AFE gain to compensate the variation in exposure time of each scan line, the main point of the invention lies in using post-processing digital gain method, which compensates exposure level of each scan line before the image data Di are sent to the image processing unit 243 for processing. Consequently, the compensation delay problem which occurs in prior arts is prevented. The digital gain unit 241 and the timer 242 can be disposed in the base of the flatbed scanner 200 as shown in FIG. 2A or disposed in the optical module 220.

Referring to FIG. 2B, a vertical view of the scanner in FIG. 2A is shown. The optical module 220 has a constant speed region and acceleration/deceleration regions at two ends of scanner 200. Different from the conventional optical module which can only scan documents in the constant speed region, the optical module 220 of the invention can also perform scan operation as moving into the acceleration/deceleration region in addition to the constant speed region. As shown in FIG. 2B, the length of the flatbed 210 is longer than that of the constant speed region. When the optical module 220 speeds up or slows down in the acceleration/deceleration region as shown in FIG. 2B, the optical module 220 reads a number of scan lines of the to-be-scanned document 211 (not shown in the figure), and then outputs the image data Di to the digital gain unit 241 of the ASIC 240.

The encoder 234 in the DC motor 230 outputs the position feedback signal PF according to a position of the optical module 220 relative to the to-be-scanned document 211 while the timer 242 calculates exposure time of each scan line according to the position feedback signal PF. Subsequently, the digital gain unit 241 can perform the digital gain process on the image data Di to compensate exposure level of each scan line read in the acceleration/deceleration region according to exposure time of each scan line.

Although exposure time of each scan line read in the acceleration/deceleration region is larger than that in the constant speed region, the exposure levels of scan lines read in the acceleration/deceleration region can still be adjusted to be constant by the gain compensation operation of the digital gain unit 241 and thus image quality can be maintained. Moreover, the acceleration/deceleration regions can be utilized to reduce the scale of the scanner 200.

Referring to FIG. 2C, a structure diagram of the scanner 200 in FIG. 2A using an automatic document feeder (ADF) is shown. The scanner 200 further includes an ADF 212 for automatically feeding documents 211 onto the flatbed 210. When a buffer-full avoiding control of the ADF 212 is performed, as shown in FIG. 2D, paper advancing velocity V decreases stably from a normal advancing velocity Vn to a constant level Vm, where Vm could be zero for ADF 212 to perform a stop-start operation, (region A), maintains constant for a period of time (region B), and then increases back to the original advancing velocity Vn (region C). Thus, the buffer-full situation can be avoided without changing data transmitting speed.

In order to avoid image jaggy issue occurring as the paper advancing velocity changes in the regions A and C due to the stop-start motion of ADF 212, the image data output by the optical module 220 during the stop-start scan are input to the digital gain unit for a digital gain process to compensate the exposure levels of scan lines read in the regions A, B and C. Therefore, by using the gain compensation operation, buffer-full issue can be avoided and image quality can be maintained as well in the ADF scanner 200.

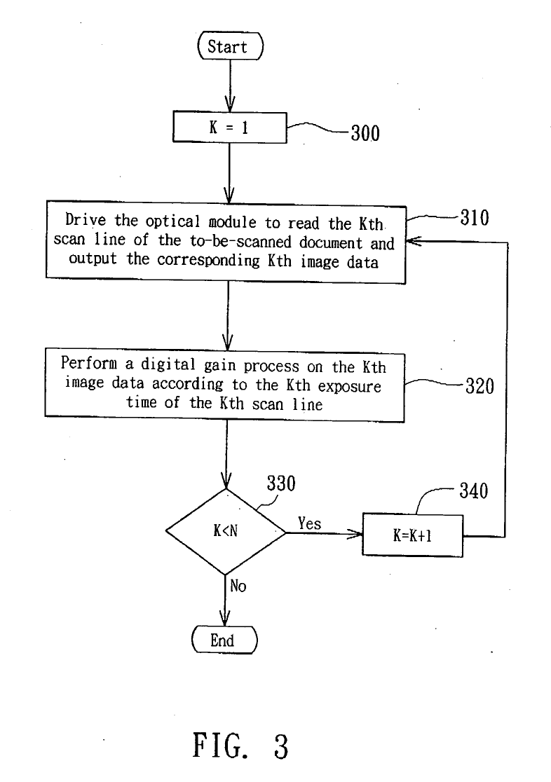

Referring to FIG. 3, a flowchart of a scanning method according to a preferred embodiment of the invention is shown. Firstly, the method begins with step 300: set the value of K to 1, wherein K is a positive integer. Next, proceed to step 310: drive the optical module 220 to read a Kth scan line of the to-be-scanned document 211 and then output corresponding Kth image data. The DC motor 230 drives the optical module 220 to a Kth position, and the encoder 234 outputs a Kth position feedback signal PF corresponding to the Kth the position. The optical module 220 reads the Kth scan line of the to-be-scanned document 211 according to the Kth position feedback signal PF.

After that, proceed to step 320: perform a digital gain process on the Kth image data to compensate the exposure level of the Kth scan line according to the Kth exposure time T(K) of the Kth scan line. The timer 242 of the ASIC 240 calculates the kth exposure time T (K) and controls a digital gain Gain(K) of the Kth scan line according to the Kth position feedback signal and the (K+1)th position feedback signal, so that the product of the T (K) and the Gain (K) is a constant, wherein K=1 to N. Lastly, proceed to step 330: determine whether K is smaller than N or not: if so, proceed to step 340 to increase K by 1 and return to the step 310, otherwise, the scanning process is completed.

As is disclosed above, despite the invention is exemplified by a reflective document 211 and a DC motor 230, the invention can be applied in a transmissive document scanner as well as in a scanner using other driving devices such as a step motor. Despite the above-mentioned preferred embodiment is exemplified by a flatbed scanner, the invention can also be applied in a sheet-fed scanner, wherein the motor drives the to-be-scanned document to be read by the photo sensing device. Since the post-processing digital gain method can be used to adjust the variation in exposure level between scan lines so as to achieve the object of a stable quality of image scanning, all these will not be apart from the skill scope of the invention.

According to the above preferred embodiment, the scanner of the invention has the following advantages:
1. Using the digital gain post-processing method to adjust the gain required for compensating the variation in exposure level of each scan line, so that both the quality of image scanning and the linearity are improved.
2. Using the digital gain post-processing method to adjust the exposure level variation among scan lines, not only improves the quality of image scanning but also prevents compensation delay problem in prior arts.
3. The digital compensation method to improve the quality of image scanning can be implemented via the ASIC hardware as in the embodiment or via computer software programs, thereby providing a better flexibility in terms of design.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A scanner, comprising:
a light source, for emitting a light beam to a to-be-scanned document;
an optical module, comprising a photo sensing device, for receiving the light beam reflected by the to-be-scanned document to read a plurality of scan lines of the to-be-scanned document and outputting corresponding digital image data;
a driving device, for generating a relative movement between the optical module and the to-be-scanned document, wherein the driving device comprises a position detecting device for detecting a position of the optical module relative to the to-be-scanned document and accordingly outputting a position feedback signal;
a digital gain unit, for performing a digital gain process on the digital image data; and
a timer, for controlling the digital gain process according to the position feedback signal to dynamically compensate exposure level of each scan line.

2. The scanner according to claim 1, wherein the timer calculates exposure time for each scan line according to the position feedback signal, and controls the digital gain process according to the exposure time to dynamically compensate the exposure level of each scan line.

3. The scanner according to claim 1, wherein the position detecting device comprises an encoder.

4. The scanner according to claim 1, wherein the photo sensing device is a charge coupled device (CCD).

5. The scanner according to claim 1, wherein the photo sensing device is a contact image sensor (CIS).

6. The scanner according to claim 1, wherein the to-be-scanned document is a reflective document.

7. The scanner according to claim 1, wherein the to-be-scanned document is a transmissive document.

8. The scanner according to claim 1, wherein the scanner is a flatbed scanner having a scan flatbed to carry the to-be-scanned document, and the driving device moves the optical module to generate the relative movement to the to-be-scanned document.

9. The scanner according to claim 1, wherein the scanner is a sheet-fed scanner having a document feeding device, and the driving device drives the document feeding device to move the to-be-scanned document to generate the relative movement to the optical module.

10. The scanner according to claim 9, wherein the digital gain process is performed to compensate the exposure level of each scan line in a buffer-full avoiding control of the document feeding device.

11. The scanner according to claim 1, wherein the digital gain process is performed to compensate the exposure level of each scan line read in an acceleration/deceleration region of the optical module.

12. The scanner according to claim 1, wherein the driving device is a direct current (DC) motor.

13. The scanner according to claim 1, wherein the driving device is a step motor.

14. The scanner according to claim 1, wherein the digital gain unit and the timer is disposed in the optical module.

15. A scanning method, applied in a scanner, for scanning a to-be-scanned document, the scanner comprising a light source, an optical module and a driving device, the light source emitting a light beam to the to-be-scanned document, the optical module comprising a photo sensing device, the photo sensing device receiving the light beam reflected by the to-be-scanned document to read the N scan lines of the to-be-scanned document, where N is a natural number, the driving device generating a relative movement between the optical module and the to-be-scanned document and outputting a position feedback signal corresponding to a relative position of the optical module to the to-be-scanned document, the method comprising: setting a K value to 1;
read a Kth scan line of the to-be-scanned document and accordingly outputting Kth image data;
calculating Kth exposure time for the Kth scan line; and
performing a digital gain process on the Kth image data according to the Kth exposure time to compensate exposure level of the Kth scan line.

16. The method according to claim 15, further comprising a step:
increasing K by 1 if the value of K is smaller than N, and returning to the step of reading the Kth scan line of the to-be-scanned document.

17. The method according to claim 15, wherein the step of reading the Kth scan line of the to-be-scanned document further comprises:
moving the optical module to a Kth position relative to the to-be-scanned document and accordingly outputting a Kth position feedback signal corresponding to the Kth position;
moving the optical module to a (K+1)th position relative to the to-be-scanned document and accordingly outputting a (K+1)th position feedback signal corresponding to the (K+1)th position; and
starting exposing the Kth scan line according to the Kth position feedback signal and ending exposing the Kth scan line according to the (K+1)th position feedback signal.

18. The method according to claim 17, wherein the Kth exposure time is determined according to the Kth position feedback signal and the (K+1)th position feedback signal.

19. The method according to claim 15, wherein the step of reading the Kth scan line of the to-be-scanned document further comprises:
moving the to-be-scanned document to a Kth position relative to the optical module and accordingly outputting a Kth position feedback signal corresponding to the Kth position;
moving the to-be-scanned document to a (K+1)th position relative to the optical module and accordingly outputting a (K+1)th position feedback signal corresponding to (K+1)th position; and
starting exposing the Kth scan line according to the Kth position feedback signal and finishing exposing the Kth scan line according to the (K+1)th position feedback signal.

20. The method according to claim 19, wherein the Kth exposure time is determined according to the Kth position feedback signal and the (K+1)th position feedback signal.

21. The method according to claim 15, wherein the digital gain process provides a Kth gain to the Kth image data, and the product of the Kth gain and the K^{th} exposure time is a constant.
